(19) United States
(12) Patent Application Publication
(10) Pub. No.: US 2005/0287329 A1
(43) Pub. Date: Dec. 29, 2005

(54) Double-sided adhesive tape

(76) Inventor: Jung-Tuzz Lai, Chung-Li (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/878,007

(22) Filed: Jun. 29, 2004

(51) Int. Cl. B32B 9/00

(52) U.S. Cl. 428/40.1

(57) ABSTRACT

An improved double-sided adhesive tape comprised of a knitted cloth basic material that is horizontally cut warp-wise, a bonding agent applied onto two surfaces of the basic material, and detachable paper affixed to the surfaces of the basic material after the deposition of the bonding agent. The features are that the textile weave density of the knitted cloth provides for the penetration of the bonding agent, the bonding agent applied onto the two surfaces congealing into a single entity such that the knitted cloth is encapsulated inside, the coalescence of the two bonding agent coatings forming a durable double-sided adhesive tape. Additionally, the weft of the knitted cloth possesses elastic stretching capability and since breakage does not occur, when removed by pulling from attached or wrapped objects, the entire length is drawn off intact and no bonding agent residue remains on the attached or wrapped objects.

### BACKGROUND OF THE INVENTION

1) Field of the Invention

The invention herein relates to an improved double-sided adhesive tape.

2) Description of the Prior Art

Conventional double-sided adhesive tape is typically available in two variations, the first being cloth strips having a bonding agent applied on two surfaces and the second being paper having a bonding agent similarly applied on two surfaces. Since the said two double-sided tape variations are simple and economical to produce and, furthermore, quite convenient to utilize, their scope of application is wide and commonplace. However, the equivalent embodiments have certain inadequacies. For example, since cloth and paper characteristically tear quite readily, after being applied to attach or wrap objects, although capable of securing effectively, when necessary to remove the equivalent embodiments, they are easily broken apart and the objects continue to stay attached or wrapped by the remaining traces of bonding agent. This not only results in arduous cleaning difficulties, but at the same time mars the pristine and attractive appearance of the attached or wrapped object surfaces.

Of course, manufacturers have now introduced high molecular polymerization double-sided adhesive tape. However, since such double-sided adhesive tape involves complicated fabrication and, furthermore, high production costs, the actual scope of utilization is not extensive and, furthermore, were formerly utilized mainly to adhesively secure mounting hooks and thus have certain deficiencies.

### SUMMARY OF THE INVENTION

The primary objective of the invention herein is to provide an improved double-sided adhesive tape in which knitted cloth that is horizontally cut warp-wise and coated on two surfaces with a bonding agent, the said bonding agent applied onto the two surfaces penetrates the textile weave of the knitted cloth and congeals into a single entity such that the knitted cloth and the bonding agent on the two surfaces coalesce into a unitary state and becomes a durable double-sided adhesive tape.

Another objective of the invention herein is to provide an improved double-sided adhesive tape in which the knitted cloth that is horizontally cut warp-wise possesses elastic stretching capability and thus does not tear or break like cloth and paper, with the congealing of the bonding agent with the knitted cloth into a single entity averting the leaving of bonding agent residue such that when removed by pulling from attached or wrapped objects, the entire length is drawn off intact and no bonding agent residue remains on the attached or wrapped objects.

Yet another objective of the invention herein is to provide an improved double-sided adhesive tape that is simple, economical, easy to use, and handy such that it is convenient and fast to apply and remove to thereby meet the requirements of genuine utility, idealness, and progressiveness.

### BRIEF DESCRIPTION OF THE DRAWINGS

FIG. 1 is an orthographic drawing of the invention herein after the warp-wise, horizontal cutting of the knitted cloth.

FIG. 2 is a cross-sectional drawing of the invention herein.

### DETAILED DESCRIPTION OF THE INVENTION

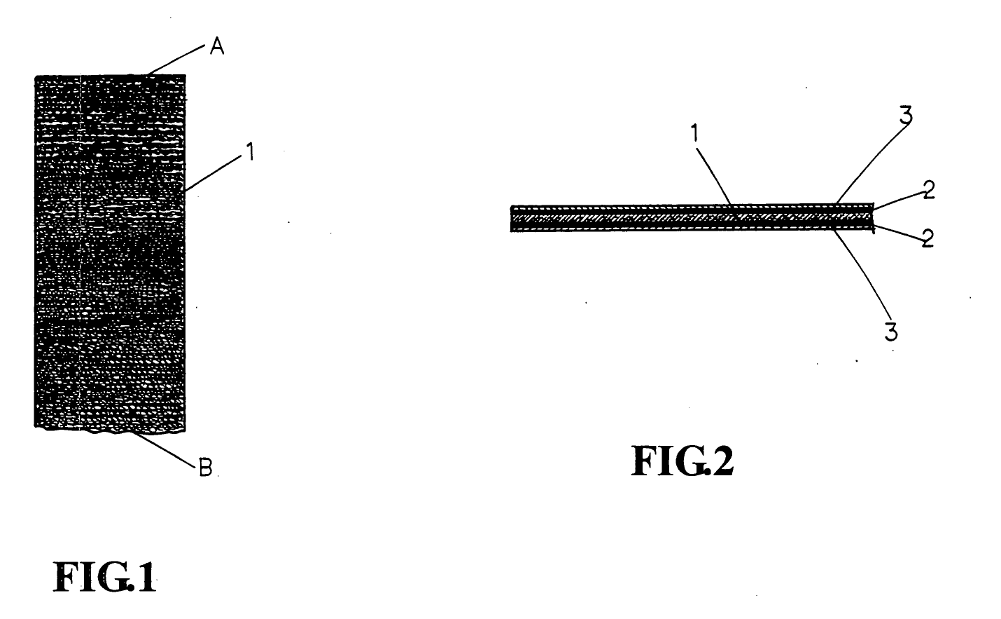

Referring to FIG. 1 and FIG. 2, the improved double-sided adhesive tape of the invention herein is comprised of a knitted cloth 1 basic material that is horizontally cut warp-wise, a bonding agent 2 applied onto the two surfaces (the upper and lower surfaces) of the knitted cloth 1, and detachable paper 3 affixed to the bonding agent 2 surfaces.

Utilizing the said structure of the invention herein, after the said knitted cloth 1 is coated on two surfaces by the said bonding agent 2, since the textile weave density of the said knitted cloth 1 provides for the penetration of the bonding agent 2, the said bonding agent 2 applied onto the two surfaces congeals into a single entity such that the knitted cloth 1 is encapsulated inside, the coalescence of the two coatings forming a durable double-sided adhesive tape. Additionally, since the weft of the said knitted cloth possesses elastic stretching capability, after the knitted cloth 1 coated on two surfaces with the bonding agent 2 is cut horizontally along the woof and thereby fabricated into a predetermined double-sided adhesive tape, the said double-sided adhesive tape naturally has a weft-wise (the orientation delineated by the two extremities A and B shown in FIG. 1) elastic stretching capability.

As such, when removal is required following object attaching or binding by the double-side adhesive tape based on the structural arrangement of the invention herein, it is only necessary to directly exert a pulling force at a weft-wise extremity (one of the extremities A or B shown in FIG. 1) and given the weft-wise elastic stretching capability possessed by the said knitted cloth 1, no breakage or tearing occurs as it is drawn off; at the same time, since the bonding agent 2 coating the two surfaces is durably coalesced with the knitted cloth 1 to form a single entity, it is pulled off intact from the objects attached or wrapped during the pulling process such that removal is complete and no bonding agent residue remains.

In other words, the invention herein has the following advantages:

1. The fabrication approach of the stretchable elastic knitted cloth 1 coated on two sides with the bonding agent 2 is simpler, more economical, and capable of broader applications than the prior art high molecular polymerization method.

2. The stretchable elastic capability knitted cloth 1 does not break as the double-sided bonding agent 2 portions are pulled during removal and, furthermore, is drawn off intact from the attached or wrapped objects such that no bonding agent residue is left behind, thereby effectively achieving an improvement over the breakage as well as the bonding agent residue drawbacks of the conventional double-sided adhesive cloth and paper tape.

1. An improved double-sided adhesive tape, the features of which are that a knitted cloth material is horizontally cut warp-wise and coated on two sides with a bonding agent, the said bonding agent applied on the said two surfaces penetrating the textile weave of the said knitted cloth and congealing into a single entity to encapsulate the said knitted cloth within and, furthermore, detachable paper is affixed to the bonding agent surfaces.
